(19) United States
(12) Patent Application Publication
(10) Pub. No.: US 2005/0155012 A1
(43) Pub. Date: Jul. 14, 2005

(54) Application creation system, creation apparatus, creation method, application providing system, providing apparatus, providing method, application operation system, operation apparatus, and operation method

(76) Inventors: Shuichi Tayama, Tokyo (JP); Yutaka Mizutori, Tokyo (JP)

Correspondence Address: BELL, BOYD & LLOYD, LLC, PO BOX 1135, CHICAGO, IL, 60690-1135, US

(21) Appl. No.: 10/504,557

(22) PCT Filed: Nov. 8, 2002
(86) PCT No.: PCT/JP02/11661

(30) Foreign Application Priority Data
Feb. 15, 2002 (JP) 2002-37668

(51) Int. Cl. G06F 9/44

(52) U.S. Cl. 717/101

(57) ABSTRACT

A server registers and manages program sources, functional modules of a plurality of applications and executable applications that a plurality of providers have provided and/or created. When a user creates an application, the server automatically creates an application that satisfies a condition that a user requests with a simple selecting or inputting operation. A unique ID is embedded in the created application. As a result, the user can be accurately and easily identified. While the server is creating an application, the server automatically creates a program corresponding to an access to the server. As a result, a service for which a user accesses to the server with an application is provided and operated.

### TECHNICAL FIELD

The present invention relates to application creating system, creating apparatus, and creating method, application providing system, providing apparatus, and providing method, and application operating system, operating apparatus, and operating method that allow application software that has a function that the user desires to be created and obtained through a network and the user to use and operate the application software.

### BACKGROUND ART

Currently, personal computers (hereinafter referred to as “PCs”, cellular phones, PDA (Personal Digital Assistants) (hereinafter the cellular phones and PDAs are collectively referred to as “portable terminal units”) have been used by many users. Users who use such PCs or portable terminal units can easily access networks. With so-called browsers or the like, the users can access the networks and browse so-called home pages (hereinafter referred to as “HPs”) that are published in predetermined areas of servers connected to the networks.

The HPs provide information and services (hereinafter simply referred to as “services”) that their providers have created to users. Most HPs are composed of text data and image data.

However, the users browse the HPs with browsers that the portable terminal units have. Thus, even if HPs provide excellent services that the browsers cannot handle to the users, they cannot receive the services. In reality, services that HPs provide depend on the specifications and OSs (Operating Systems) of PCs and portable terminal units that the users have.

As the number of users who connect networks is increasing, PCs or portable terminal units have been drastically innovated. To satisfy various needs of users, software of application programs (hereinafter referred to as “applications”) that operate on PCs or portable terminal units has been designed to provide multiple functions. Thus, the capacities of applications have become large. There are many applications that do not comfortably operate unless PCs and portable terminal units on which the applications operate do not have calculation performances and memory capacities sufficient for the applications. In particular, it is difficult for portable terminal units that have lower calculation performances and smaller memory capacities than PCs to operate large applications.

In such an environment, users are looking for applications that are easy and convenient and that satisfy their needs to some extent at stores and sales companies or on networks. The users install the obtained applications to their PCs or portable terminal units and use the installed applications therewith.

However, the PCs and portable terminal units have various models and specifications. Thus, to look for applications that satisfy users' needs at stores and sales companies or on networks, they should spend their labor.

On the other hand, there is a service of which applications are downloaded from HPs and provided to users. Since this service provides applications that providers have created to users, the applications have been created from a view point of the provider's side. In addition, depending on the type of a service, users should always connect their PCs or portable terminal units to the networks. Thus, the users should spend the cost for the always connection to the networks.

When the users and providers distribute applications through networks, they should establish distributing systems or distributing schemes. At that point, establishment of the environmental configuration of the network and system and the knowledge and cost thereof are required. Likewise, to transfer applications to a third party such as a friend, an acquaintances, or a customer, it is necessary to consider the transferring method, system, place, and time.

In addition, many users use only parts of functions of applications, not all multiple functions thereof. It is preferred that applications should be provided to users with functions that they desire at costs corresponding to the functions. In other words, applications that users have customized and that they have order-made are desired rather than pre-created applications.

However, to create applications, special technical knowledge is required. Thus, when a user orders an application that has only functions he or she desires, extra cost and time are required. Thus, many users cannot obtain applications that satisfy their needs.

In addition, conventionally, applications are recorded on mediums such as CD-ROMs or the like and provided as packages and sold at stores or directly downloaded from HPs using browsers or the like. When applications are directly downloaded, serial numbers or the like are provided to users so as to permit or restrict the use and operation of the applications.

However, in such methods, applications cannot be prevented from being illegally copied. In reality, since the provider side does not know who have obtained applications, it was impossible to prevent them from being illegally copied using mediums such as CD-ROMs and serial numbers.

From the foregoing point of view, an object of the present invention is to provide application creating system, creating apparatus, and creating method, application providing system, providing apparatus, and providing method, and application operating system, operating apparatus, and operating method that allow an application that a user desires to be easily created, obtained, and used through a network, an application to be easily distributed, user's obtainment and/or use information to be managed and/or operated, and an application to be prevented from being illegally copied.

### DISCLOSURE OF THE INVENTION

The present invention is an application creating system for creating application software that a user desires, the application creating system comprising a user's terminal unit connected through a network; application managing means for managing the application software; function selecting/inputting means for selecting and/or inputting a desired function of the managed application software with the user's terminal unit; and application creating means for creating application software in accordance with the desired function that has been selected and/or input and specifications of the user's terminal unit that uses the application software.

The present invention is an application creating apparatus for creating application software that a user desires, the application creating apparatus comprising application managing means for managing the application software; function selecting/inputting means for selecting and/or inputting a desired function of the managed application software; and application creating means for creating application software in accordance with the desired function that has been selected and/or input and specifications of a user's terminal unit that uses the application software, wherein the application creating apparatus is controlled with the user's terminal unit connected thereto through a network.

The present invention is an application creating method for creating application software that a user desires, the application creating method comprising the steps of managing the application software; selecting and/or inputting a desired function of the managed application software; and creating application software in accordance with the desired function that has been selected and/or input and specifications of a user's terminal unit that uses the application software, wherein the application creating method is controlled with the user's terminal unit connected thereto through a network.

The present invention is an application providing system for providing application software that a user desires, the application providing system comprising a user's terminal unit connected through a network; application managing means for managing the application software; application creating means for selecting and/or inputting a desired function of the managed application software with the user's terminal unit and creating application software in accordance with the desired function that has been selected and/or input and specifications of the user's terminal unit; and application providing means for providing the created application software to the user's terminal unit so that the created application software is used with the user's terminal unit.

The present invention is an application providing apparatus for providing application software that a user desires, the application providing apparatus comprising application managing means for managing the application software; application creating means for selecting and/or inputting a desired function of the managed application software and creating application software in accordance with the desired function that has been selected and/or input and specifications of a user's terminal unit that uses the application software; and application providing means for providing the created application software to the user's terminal unit so that the created application software is used with the user's terminal unit, wherein the application providing apparatus is controlled with the user's terminal unit connected thereto through a network.

The present invention is an application providing method for providing application software that a user desires, the application providing method comprising the steps of managing the application software; selecting and/or inputting a desired function of the managed application software and creating application software in accordance with the desired function that has been selected and/or input and specifications of a user's terminal unit that uses the application software; and providing the created application software to the user's terminal unit so that the created application software is used with the user's terminal unit, wherein the application providing method is controlled with the user's terminal unit connected thereto through a network.

The present invention is an application operating system for providing application software that a user desires, the application operating system comprising a user's terminal unit connected through a network; application managing means for managing the application software; application creating means for selecting and/or inputting a desired function of the managed application software with the user's terminal unit and creating application software in accordance with the desired function that has been selected and/or input and specifications of the user's terminal unit; and application managing•operating means for managing and operating the created application software so that the created application software is used with the user's terminal unit through the network.

The present invention is an application operating apparatus for providing application software that a user desires, the application operating apparatus comprising application managing means for managing the application software; application creating means for selecting and/or inputting a desired function of the managed application software and creating application software in accordance with the desired function that has been selected and/or input and specifications of a user's terminal unit that uses the application software; and application managing•operating means for managing and operating the created application software so that the created application software is used with the user's terminal unit through the network, wherein the application operating apparatus is controlled with the user's terminal unit connected thereto through a network.

The present invention is an application operating method for providing application software that a user desires, the application operating method comprising the step of managing the application software; selecting and/or inputting a desired function of the managed application software and creating application software in accordance with the desired function that has been selected and/or input and specifications of a user's terminal unit that uses the application software; and managing and operating the created application software so that the created application software is used with the user's terminal unit through the network, wherein the application operating method is controlled with the user's terminal unit connected thereto through a network.

According to the present invention, a user can access a network with a user's terminal unit and automatically create application software that has a function that the user desires. The user can use the created application software with the user's terminal unit.

### BRIEF DESCRIPTION OF DRAWINGS

FIG. 1 is a block diagram showing a system that can provide a service according to the present invention;

FIG. 2 is a schematic diagram describing the present invention;

FIG. 3 is a schematic diagram describing the present invention;

FIG. 4 is a schematic diagram describing the present invention;

FIG. 5 is a schematic diagram describing the present invention;

FIG. 6 is a schematic diagram describing the present invention;

FIG. 7 is a schematic diagram describing the present invention; and

FIG. 8 is a schematic diagram describing the present invention.

### BEST MODES FOR CARRYING OUT THE INVENTION

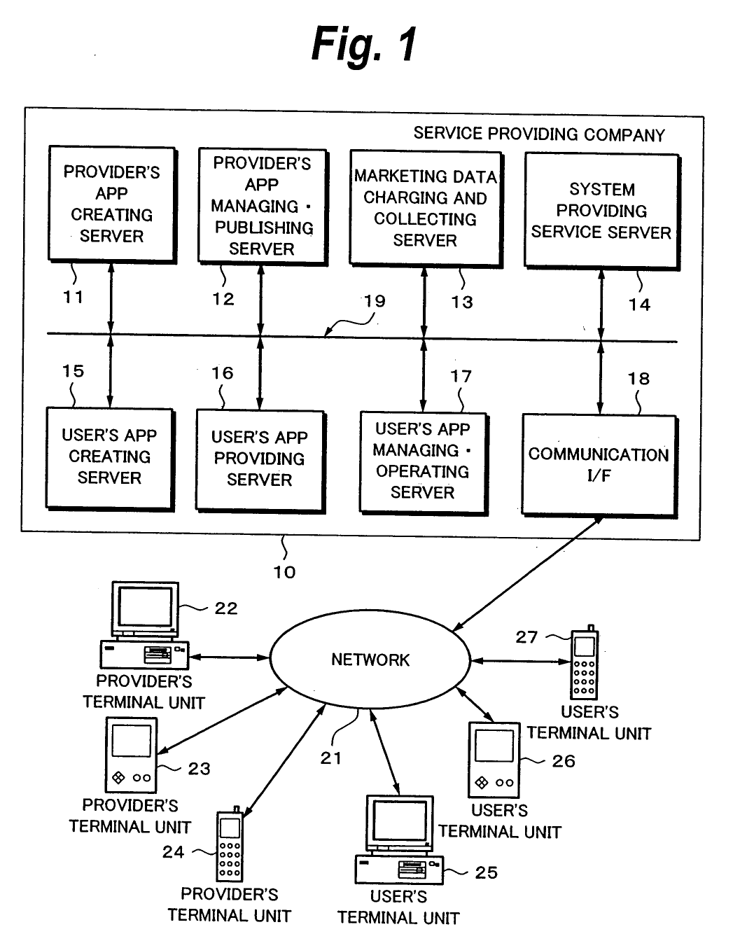

Next, with reference to the accompanying drawings, an embodiment of the present invention will be described. In each drawing, portions having similar functions will be denoted by similar reference numerals so as to prevent their description from being redundant. FIG. 1 shows the overall structure of a system according to the embodiment of the present invention.

A service providing company 10 has a provider's application (App) creating server 11, a provider's application managing•publishing server 12, a marketing data charging and collecting server 13, a system providing service server 14, a user's application creating server 15, a user's application providing server 16, a user's application managing•operating server 17, and a communication interface (I/F) 18 that are connected through a network 19.

Program sources, functional modules, and/or executable applications of a plurality of applications provided by a plurality of providers have been registered to the provider's application creating server 11. The program sources and/or functional modules registered in the provider's application creating server 11 are automatic application creating systems that can create applications. The program sources and/or functional modules are written in for example the C language or Java (registered trademark) language.

The provider's application managing•publishing server 12 manages providers of applications, applications registered in the provider's application creating server 11, charging information that has been set for each application, and so forth. The managed applications are published to the users on a HP by the user's application creating server 15 or the like.

The marketing data charging and collecting server 13 calculates the fee of an application that the user has used. The service providing company 10 collects the calculated fee from the user instead of the provider. The service providing company 10 pays the collected fee to the provider that has provided the application. In addition, the marketing data charging and collecting server 13 determines users' favorites in accordance with applications that the users have used. When a new application that corresponds to the users' favorites is registered to the provider's application creating server 11, the service providing company 10 informs the users of the registered application by electronic mail or the like. In addition, the service providing company 10 reports the determined users' favorites to the providers. The users may be charged for applications when the providers have created the applications or when the users have used them. Alternatively, the users may be charged for applications whenever they use them.

The marketing data charging and collecting server 13 may not be disposed in the service providing company 10. In other words, a service that has the same function as the marketing data charging and collecting server 13 may be used through a network. For example, the service providing company 10 may tie up with a service providing company that has the function of the marketing data charging and collecting server 13 and use the service through a network.

The system providing service server 14 is used when the system of the service providing company 10 is provided as an OEM or when a created application is provided to a third party such as a friend, an acquaintance, or a customer. Thus, the system providing service server 14 creates a HP that a third party browses.

The user's application creating server 15 creates an application that satisfies a condition that a user desires. The user's application creating server 15 is composed of a system that can automatically create applications. With a program source, a functional module, and/or an executable application registered in the provider's application creating server 11, the user's application creating server 15 can create an application. When the created application is an application that is downloaded, it is stored in the user's application providing server 16. When the created application is an application that is used through a network, the application is stored in the user's application managing•operating server 17. In addition, the user's application creating server 15 provides a dedicated HP having a searching function that allows a user to find an application that satisfies a condition that the user desires.

The user's application creating server 15 pre-stores modules of a program for the environmental configuration of the network, a program for the environmental configuration of the system, a program for the distribution, and/or a program source. An operation program necessary for the user to download an application or an operation program necessary for the user to use an application through the network 21 is automatically created when the application is created. When the application is used, the environmental configuration can be automatically established. At that point, a program and/or a program source may be presented to the user in accordance with the selected program source, functional module, and/or executable application.

The user's application providing server 16 stores an application that has been created applications in accordance with a condition that a user desires and that will be downloaded to a user's terminal unit 25, 26, or 27. The stored application is provided to the user through the user's dedicated HP. In other words, the application is downloaded to the user's terminal unit 25, 26, or 27 through the user's dedicated HP.

The user's application managing•operating server 17 stores an application that has been created in accordance with a condition that a user desires and that will be used through the network 21. The stored application is provided to the user through the user's dedicated HP. In other words, when a user selects an application on the user's dedicated HP, the user can use the selected application on the user's terminal unit 25, 26, or 27. In addition, the user's application managing•operating server 17 manages an application that is used through the network 21. For example, the user's application managing•operating server 17 manages a situation of which the same application is used by a plurality of users through the network 21.

As long as the communication interface 18 can be connected to the network 21, the type of the communication interface 18 is not restructured. For example, the communication interface 18 is composed of a rooter or the like. The network 21 is for example the Internet.

A provider's terminal unit 22 is a PC that accesses the service providing company 10 through the network 21. A provider's terminal unit 23 is a PDA that accesses the service providing company 10 through the network 21. A provider's terminal unit 24 is a cellular phone that accesses the service providing company 10 through the network 21. According to the present embodiment, as examples of the provider's terminal units, a PC, a PDA, and a cellular phone are shown. However, besides them, any types of units can be used as long as they can use a network and an application.

A user's terminal unit 25 is a PC that accesses the service providing company 10 through the network 21. A user's terminal unit 26 is a PDA that accesses the service providing company 10 through the network 21. A user's terminal unit 27 is a cellular phone that accesses the service providing company 10 through the network 21. According to the present embodiment, as examples of user's terminal units, a PC, a PDA, and a cellular phone are shown. However, besides them, any types of units can be used as long as they can use a network and an application.

Next, an example of the overall operation of the system will be described. To simplify the description, it is assumed that one provider uses the provider's terminal unit 22 and one user uses the user's terminal unit 25. However, when the provider uses the provider's terminal unit 23 or 24, the same operation and effect as the provider's terminal unit 22 are obtained. Likewise, when the user uses the user's terminal unit 26 or 27, the same operation and effect as the user's terminal unit 25 are obtained.

In addition, it is assumed that the provider's terminal unit 22 and the user's terminal unit 25 are not special PCs. To simplify the description, a PC that the provider operates is referred to as provider's terminal unit 25 and a PC that the user operates is referred to as user's terminal unit 25. Thus, with the user's terminal unit 25, program sources, functional modules, and/or executable applications of a plurality of applications can be provided. Likewise, with the provider's terminal unit 22, applications can be created and used.

Likewise, the provider's terminal unit 23 and the user's terminal unit 26 are not special PDAs. To simplify the description, a PDA that the provider operates is referred to as provider's terminal unit 23 and a PAD that the user operates is referred to as user's terminal unit 26. In addition, the provider's terminal unit 24 and the user's terminal unit 27 are not cellular phones having special functions. To simplify the description, a cellular phone that the provider operates is referred to as provider's terminal unit 24 and a cellular phone that the user operates is referred to as user's terminal unit 27.

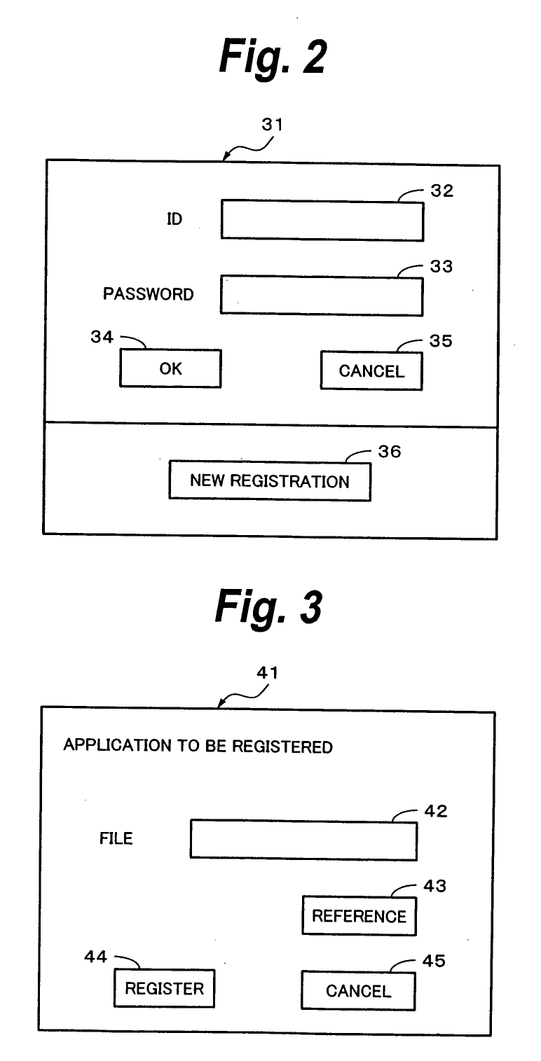

With the provider's terminal unit 22, the provider accesses the service providing company 10 through the network 21. When the provider's terminal unit 22 accesses the service providing company 10, a screen 31 as shown in FIG. 2 appears so as to input an ID (identity) and a password.

The screen 31 has an ID entry field 32, a password entry field 33, an OK button 34, a cancel button 35, and a new registration button 36. The ID entry field 32 is a field for an ID assigned to each provider or each user. The password entry field 33 is a field for a password assigned to each provider or each user. Generally, an ID and a password are managed as a pair. After the provider has input his or her ID and password, he or she clicks the OK button 34 so as to receive a service from the service providing company 10. When the provider cancels the service of the service providing company 10 on the screen 31, he or she clicks the cancel button 35. When a non-registered provider wants to newly receive a service from the service providing company 10, he or she clicks the new registration button 36. When the non-registered provider registers with the service providing company 10, he or she should register at least his or her name and e-mail address.

With the provider's terminal unit 22, the provider inputs the pre-assigned ID to the ID entry field 32. Thereafter, the provider inputs the pre-assigned password to the password entry field 33. Thereafter, the provider clicks the OK button 34. When the provider clicks the OK button 34, it is determined whether or not the input ID and password have been formally registered. When the determined result represents that the input ID and password have been formally registered, a screen 41 as shown in FIG. 3 appears so as to register an application, a program source, and/or a functional module.

The screen 41 has a file designation field 42, a reference button 43, a registration button 44, and a cancel button 45. In the file designation field 42, the provider designates a file of an application, a program source, and/or a functional module. The reference button 43 is a button that causes the file structure of the PC to be displayed so that the provider can easily designate a file of an application, a program source, and/or a functional module. The registration button 44 is a button that causes a file designated in the file designation field 42 to be registered. The cancel button 45 is a button that causes a file designated in the file designation field 42 to be cancelled.

When the provider designates a file in the file designation field 42 and clicks the registration button 44 with the provider's terminal unit 22, the file is stored in the provider's application creating server 11 and the provided application is managed by the provider's application managing•publishing server 12. The application is published with a HP to the user. An application that the provider registers to the service providing company 10 may be an application that can be used by the user, an application that the provider has customized, a program source, and/or a functional module.

In such a manner, with the provider's terminal unit 22, the provider registers a program source of an application to the provider's application creating server 11 through the network 21. At that point, the provider can only register a program source of an application, a program source, and/or a functional module rather than an environmental configuration of the network and a program source with respect to the distribution. In other words, the provider does not need to have knowledge about an environmental configuration of the network and the distribution.

An advertisement of the provider may be placed on the HP of the service providing company 10. In addition, the HP of the service providing company 10 may be linked to the HP of the provider. Moreover, the HP of the service providing company 10 may link the HP of the provider.

Next, an example of which the user accesses the service providing company 10 with the user's terminal unit 25 through the network 21 will be described. Like the provider, when the user accesses the service providing company 10, the screen 31 appears as shown in FIG. 2 so as to input an ID and a password.

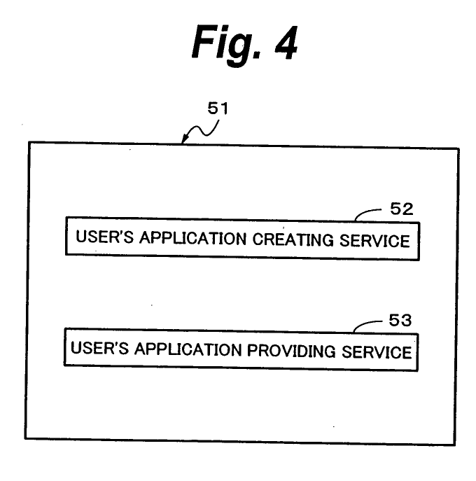

With the user's terminal unit 25, the user inputs the pre-assigned ID in the ID entry field 32. Thereafter, the user's terminal unit 25 inputs the pre-assigned password in the password entry field 33. Thereafter, the user clicks the OK button 34. When the user clicks the OK button 34, it is determined whether or not the input ID and password have been formally registered. When the determined result represents that the input ID and password have been formally registered, a screen 51 appears as shown in FIG. 4.

The screen 51 is a screen on which the user selects a user's application creating service or a user's application providing service that the service providing company 10 provides. Thus, the screen 51 has a user's application creating service button 52 and a user's application providing service button 53.

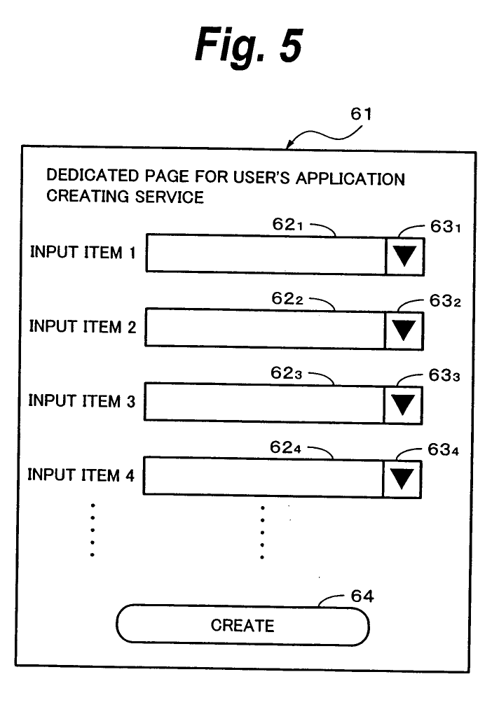

Next, an example of which the user clicks the user's application creating service button 52 on the service selecting screen shown in FIG. 4 will be described. When the user's application creating service button 52 is clicked, a screen 61 appears as shown in FIG. 5. The screen 61 has an input field 62₁ for an input item 1, an input field 62₂ for an input item 2, an input field 62₃ for an input item 3, an input field 62₄ for an input item 4, . . . , and a creation button 64. FIG. 4 shows for example four input items. On the right of the input field 62₁, an item indication button 63₁ with which an item is selected on a pull-down menu is disposed. Likewise, on the right of the input field 62₂, an item indication button 63₂ is disposed. On the right of the input field 62₃, an item indication button 63₃ is disposed. On the right of the input field 62₄, an item indication button 63₄ is disposed.

The user can directly input data in the input fields 62₁, 62₂, 62 ₃, and 62₄ with the user's terminal unit 25. Alternatively, the user can select items from the item indication buttons 63₁, 63₂, 63₃, and 63₄. In addition, searched results of the searching function of the HP may affect the input fields 62₁, 62₂, 62₃, and 62₄.

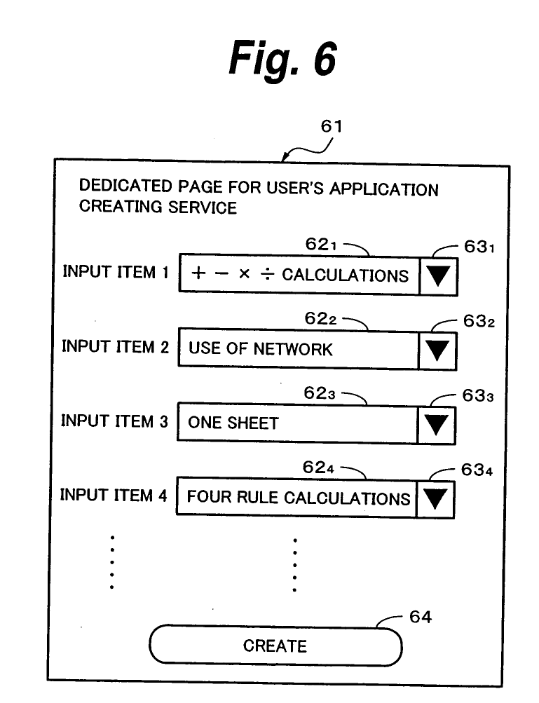

FIG. 6 shows an example of selected items. In the input item 1, an application is selected. In the example, in the input item 1, a spreadsheet application “+, −, X, +calculations” has been selected. In the input item 2, “use of network” for which the application selected in the input item 1 is used through the network has been selected. In the input item 3, “one sheet” for the spreadsheet application “+, −, X, +calculation” has been input. In the input item 4, “four rule calculations” for the spreadsheet application “+, −, X, +calculations” has been input. In such a manner, the user selects and/or inputs functions for individual objects of the desired application.

In the example, in the input item 1, an application has been selected. In the other input items, a structure of the selected application has been designated. However, the order of selections is not restricted to the foregoing example. For instance, in the input item 1, “four rule calculations” may be selected. In the input item 2, the number of sheets may be selected. In the input item 3, “use of network” may be selected. In the input item 4, “spreadsheet” application may be selected. When they are input, a spreadsheet application that satisfies all functions may be selected.

At that point, an application that another user has created may be selected.

After a desired application and desired input items have been designated, the create button 64 is clicked. When the create button 64 is clicked, the user's application creating server 15 creates an application that has desired functions (input items).

In such a manner, the user uses the searching function of the dedicated HP that the user's application creating server 15 provides so as to search his or her desired application. Thereafter, the user inputs his or her desired specifications and various types of information for the input items. The user's application creating server 15 automatically creates an application in accordance with user's desired specifications and various types of information. In reality, the application is compiled so that it contains functions (modules) that the user has selected in the input items.

The automatically created application can be downloaded to the user's terminal unit 25 through the network 21 or used as an application that can be executed on the network 21 in accordance with user's desired specifications.

At that point, the type of the PC or portable terminal unit may be input in an input item. Alternatively, the type of the PC or portable terminal unit may be categorized in accordance with the ID and password. In other words, when the user registers with the service providing company 10, the type of the PC or portable terminal unit may be checked. Alternatively, an ID and a password may be issued for each PC or each portable terminal unit. Alternatively, a control signal for obtaining model information that represents the model the user's terminal unit 25 may be transmitted from the service providing company 10 to the user's terminal unit 25. In response to the control signal, the user's terminal unit 25 may transmit the model information to the service providing company 10 so that the service providing company 10 can obtain the model information of the user's terminal unit 25. Alternatively, along with the model information, the OS of the PC or portable terminal unit and the OS version may be obtained.

Since a conventional spreadsheet application can use various functions and many sheets and have many sum-up formats, the capacity of the program is large. In contrast, since the foregoing spreadsheet application can use only the four rule calculations, it needs only one sheet, the capacity of the spreadsheet application can be kept small. Thus, even if a unit that has a low calculating performance and a small memory capacity, the unit can comfortably operate. Thus, with only desired functions that the user selects from various functions (modules) of an application, he or she can obtain a spreadsheet application that operates fast.

The created application is stored in the user's application providing server 16 or the user's application managing•operating server 17. The user's application providing server 16 and the user's application managing•operating server 17 collect applications for each user like a database and publish the collected applications on each user's dedicated HP.

When a created application is transferred to a third party, he or she is informed of the URL (Uniform Resource Locator) of the third party's HP by e-mail. At that point, the URL may be e-mailed from the service providing company 10 to the third party. Alternatively, the user may e-mail the URL to the third party. The third party may access the third party's dedicated HP in accordance with the received URL, download the application therefrom, and use the same application as the user. Alternatively, the third parity may access the third party's dedicated HP in accordance with the received URL and share the application with the user through the network.

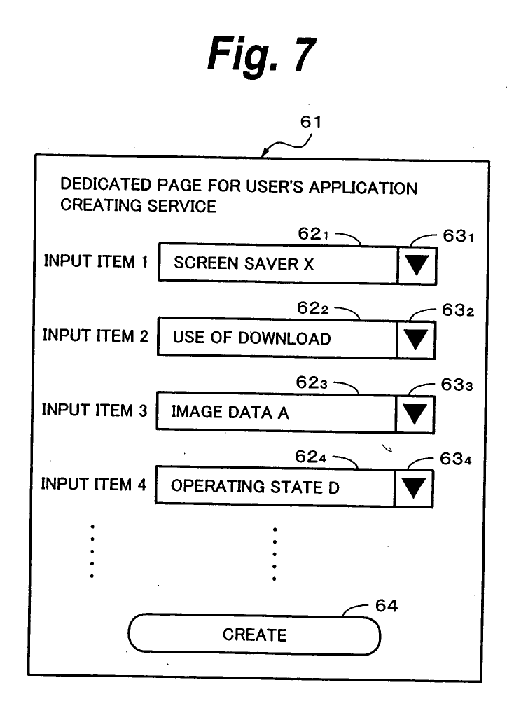

FIG. 7 shows another example of which items have been selected. In the input item 1, an application is selected. In the example, in the input item 1, an application “screen saver X” has been selected. In the input item 2, “use of application” for which the application selected in the input item 1 is downloaded and used has been selected. In the input item 3, “image” as one element of “screen saver X” has been selected. At that point, image data provided on the HP, user's image data, or the like can be selected. In the example, “image data A” has been selected. In the input item 4, one operating state as one element of “screen saver X” has been selected. For example, an operating state of fade-in/fade-out, a motion on the screen, or a slide-show is selected for image data. In the example, operating state D has been selected.

In FIG. 7, a time period such as a display period for a motion of image data (not shown), a time period until a screen saver operates, and/or a process for stopping the screen saver, for example a screen saver stopping system using a password may be created as one application.

On the screen 61 shown in FIG. 6 and FIG. 7, four input items are disposed. However, it should be noted that more input items may be disposed. Alternatively, an input item adding button may be disposed on the screen 61. At that point, whenever the input item adding button is pressed, an input item may be added.

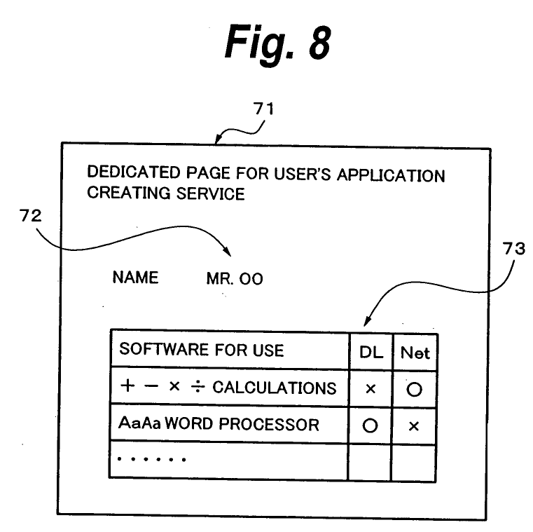

An example of which the user clicks the user's application providing service button 53 on the service selection screen shown in FIG. 4 will be described. When the user clicks the user's application providing service button 53, an application stored in the user's application providing server 16 and/or the user's application managing•operating server 17 is displayed as a user's dedicated HP on a screen of the user's terminal unit 25. FIG. 8 shows an example of the screen of the user's dedicated HP. A screen 71 shown in FIG. 8 has an area 72 for a registered user name and a table 73 of a list of applications that the user has created. In other words, the screen 71 is a screen of a user's dedicated HP that a user who does not know an ID and a password cannot browse.

The table 73 has an application name field for applications that the user has created, a download field that represents whether or not the corresponding application is downloaded and used, and a network field that represents whether or not the corresponding application is used through the network. When the user clicks an application name on the table 73, the application may operate. The table 73 is composed of a database of applications collected for each user from the user's application providing server 16 and/or the user's application managing•operating server 17.

Next, an example of a schedule management application (not shown) will be described. An indication format that indicates a normal alert or an indication format that uses multimedia moving characters, a moving picture, an animation, sound, music, and so forth is selected. In the selected indication format, characters on the HP can be freely customized and a multimedia pattern can be freely selected on the HP.

In addition, a plurality of timings of a remind indication can be selected. Multimedia as a remind indication can be selected at each timing. The number of timings and indication times of a remind indication can be freely designated for example three timings of 5 pm on the preceding day of the event, 10 am of the event day, and one hour before the event or four timings adding 10 minutes before the event.

In addition, since a schedule management application can be applied to a third party, if third party members are designated, a schedule can be distributed to them. When a party schedule has been made by a particular group, the schedule can be distributed to all the group members.

In such a manner, an alert indication method, a timing thereof, the number of times thereof, and a user and/or a third party to which the alert is distributed can be freely designated. In addition, such an application can be used in a small communication group.

In other words, an application that can be used by any unit that is neither a PC nor a portable terminal unit and that can be connected to the network 21 can be provided.

In reality, the user can correct, add, delete, and browse a schedule with a PC at home, a PDA, a cellular phone, or a PC at office using a schedule management application. At that point, since the user can see an alert with a PC or a cellular phone closest to him or her, he or she can be securely informed of the designated schedule.

Thus, the service providing company 10 can easily provide services for cellular phone applications and PC cross platform applications using Java (registered trademark) and sell download applications.

As described above, when an application is created, functions are input to input items one by one. Alternatively, so-called basic sets that contain basic items of applications may be provided. With a basic set that is selected, an application may be created.

In addition, a function that is not contained in a selected basic set, namely an optional additional module and another basic set may be selected. By combining the selected additional module or another basic set to a pre-selected basic set, a desired application may be created. In that case, when an application is created, although a relatively complicated process is required, an application that has an advanced function and that satisfies user's needs can be provided to the user.

In addition, when an application is created, undesired functions can be deleted from a basic set. In that case, the application can be provided to the user at a low cost corresponding to the deleted functions. In addition, since the application executable module becomes relatively small, the resource necessary for the application can be reduced. Thus, the user's terminal unit 25 can be prevented from becoming insufficient in its resource. In that case, a simpler and more explicit interface can be provided than the case that an application is created by adding and combining functions.

Besides a combination of functional elements that compose an application, messages, images, sounds, and so forth can be freely set so as to use and provide an application. As a result, a totally customized application can be provided to the user.

An application provider may provide an application to not only an application creator (user), but a third party that the user has designated. In that case, the execution environmental configurations of an application may vary for individual users. For example, when an application is executed by a PC, a cellular phone, or a PDA, although the function of the application is the same, since their interfaces are different, executable modules may be different. In addition, the user may not know an execution environmental configuration of a designated third party. However, this system determines an operation environmental configuration and/or an operating state of a terminal unit that requests the system to download an application and automatically provides to the terminal unit an executable module corresponding to an environmental configuration thereof. Thus, according to the present embodiment, an application corresponding to the environmental configuration of the user's terminal unit can be provided to the user.

In addition, cellular phones that correspond to the same standard may execute the same application with different screen resolutions depending on their models. Thus, for one application, a plurality of application versions corresponding to various functions (environmental configurations) are provided. The user's application providing server 16 or the user's application managing•operating server 17 automatically determines a model of a unit that has accessed the system and requests it to download the application and provides an application corresponding to the determined model to the unit.

When the user happens to need an additional function in a downloaded application that he or she has used or thinks that he or she does not need a part of a function in the application, he or she can re-customize the application using the system. In addition, when an application provider side provides a new function of an application, the user can build the function in the application for a version-up.

According to the present embodiment, when a provider or a user accesses the service providing company 10, it requests the provider or the user to input an ID and a password. Alternatively, the service providing company 10 may request the provider or the user to input any one of an ID and a password. Alternatively, when an application is used, an ID and/or a password may be requested to be input. In the case that a plurality of users use one application, when they use the application, they may be individually requested to input their IDs and/or passwords.

In addition, since the present embodiment is a system of which a user creates an application when he or she wants it. Thus, when a user creates an application, he or she can embed a unique identifier (hereinafter referred to as “unique ID”) in an executable module of the application. When an application of which a unique ID has been embedded in an executable module is operated with the user's terminal unit 25, the unique ID is exchanged between the user's application managing•operating server 17 and the user's terminal unit 25. As a result, the user can be accurately and easily identified.

For example, a user needs to input his or her name or his or her ID and password in addition to his or her name so that a server or a third party can identify the user. However, when the user manually input them, he or she may feel troublesome. On the other hand, if the user is identified with only a simple ID or his or her name, a false name can be used.

Thus, when a unique ID embedded in an executable module of an application is used, since the application can autonomously request the server to identify the user, the user's manual input operation can be omitted. In addition, the server can accurately identify the user. Moreover, in the system, since a unique ID is autonomously used by an application, not exposed to the user or third party, it is impossible for the user to intentionally to leak the unique ID out to the others.

In reality, in a communication application, for example an application for which data is written to a management server such as a bulletin board application, a user who wrote data to the server can be automatically identified. Thus, the user does not need to input his or her name whenever he or she inputs data as a speaker. In addition, a malicious user can be prevented from using a false name.

In a game application having a ranking function, since a user who played a game can be automatically identified, the user's points (score) of the game can be easily registered. In addition, a foul play protection function can be provided. Thus, the user can easily browse his or her score.

For an application that requires to communicate with a server, a function of the server can be decided in accordance with the unique ID. In addition, when a unique ID, a regular ID, and a password are requested to be input, a user can be more securely identified.

Moreover, to protect a content that is provided to only a predetermined user, a unique ID can be used. When an information sharing tool such as schedule data, namely a groupware application is operated, it is necessary to keep the schedule data secret in the group. Thus, when a unique ID is used, the server can identify a group to which the user who is trying to access the server belongs. When the group to which the user belongs is identified, schedule data of the identified group is provided to the user. With a unique ID, a server resource that an application can access can be easily identified. In addition, a unique ID has a function for preventing data from being illegally accessed.

Although the foregoing unique ID has been embedded in an operation module of an application, when a provider and/or a user registers with the service providing company 10, a unique ID may be registered. In that case, when the provider and/or the user accesses the service providing company 10 with the provider's terminal unit 22 and/or the user's terminal unit 25, the provider and/or the user can be identified. As a result, a service corresponding to the provider and/or the user can be provided thereto.

An application created and operated according to the present embodiment can communicate with the user's application providing server 16 or the user's application managing•operating server 17 basically at any timing. Thus, the user's application providing server 16 or the user's application managing•operating server 17 can know the operating state of each application that they provide using for example a unique ID time by time. Thus, when means for collecting data that represents an operating state of each application is disposed, the service providing company 10 can effectively collect the data that represents the operating state of each application.

Alternatively, the foregoing user's application providing server 16 or the user's application managing•operating server 17 may have a download controlling function. For example, the user's application providing server 16 or the user's application managing•operating server 17 controls permission/prohibition for a content of the server and/or the network. In addition, the download controlling function has a safety operation function that automatically prohibits a content from being abnormally downloaded.

In addition, the user's application providing server 16 or the user's application managing•operating server 17 may have an operation controlling function. The operation controlling function is a function for controlling the user's application providing server 16 or the user's application managing•operating server 17 to respond to a communication from an application. In that case, with a unique ID that allows the operating state of the application to be obtained time by time, the user's application providing server 16 or the user's application managing•operating server 17 may be controlled to replay a communication from an application.

Alternatively, the user's application providing server 16 or the user's application managing•operating server 17 may have an application start controlling function. When an application that has been expired is started, the application start controlling function causes a message that represents that the application cannot be used to be displayed on the user's terminal unit 25 and completes the execution of the application. In that case, likewise, with a unique ID that allows the operating state of the application to be obtained time by time, the startup of the application may be controlled.

In addition, when a unique ID is applied to the user's application providing server 16 or the user's application managing•operating server 17, whenever an application that has been distributed is installed, one ID can be assigned. For example, when a user installs an application to all of a PC, a PDA, and a cellular phone and he or she uses the application with them, three IDs are assigned to them so as to manage the user and the application. Thus, since a user, a time, and a terminal unit about which an application has been installed can be accurately determined, the user can be easily managed. In addition, an application can be prevented from being illegally copied.

According to the present embodiment, the system providing service server 14 creates a HP that a third party browses. Alternatively, a third party may browse the user's dedicated HP that the user's application providing server 16 and the user's application managing•operating server 17 create.

According to the present embodiment, a program source necessary for a network environmental configuration, a program source necessary for a system environmental configuration, and a program source necessary for a distribution are pre-provided as modules to the user's application creating server 15. In addition, modules corresponding to specifications and model information of various PCs or portable terminal units may be provided.

According to the present embodiment, the servers 11 to 17 of the service providing company 10 are connected through the network 19. Alternatively, the network 19 may be the Internet. In addition, the servers 11 to 17 may be owned by different companies.

According to the present embodiment, the network 21 is for example the Internet. However, as long as a network can be structured, the network 21 is not restricted to the foregoing example. For instance, the network 21 may be a telephone line, a network service of a CATV (Cable Television), a network service for cellular phones, or the like. Of course, the network 21 may be structured using a dedicated line, a ground wave, or a satellite wave. In addition, as a communication system, a peer-to-peer connection of which many terminal units are directly connected and information is shared thereamong may be used.

According to the present embodiment, program sources and/or functional modules registered in the provider's application creating server 11 are written in the C language or Java (registered trademark) language. However, according to the present invention, any language can be used as long as program sources and/or functional modules can operate with a PC.

According to the present embodiment, the user's application providing server 16 that stores applications that are downloaded and used by users and the user's application managing•operating server 17 that stores applications that users use through a network are disposed. Alternatively, a server that integrates the user's application providing server 16 and the user's application managing•operating server 17 may be used.

According to the foregoing embodiment, a provider provides files of an application, a program source, and/or a functional module and so forth. Alternatively, the provider himself or herself may create an application having his or her desired function and use it using the service providing company 10.

According to the present invention, a provider can use an application that he or she has created with various types of PCs or portable terminal units without need to know the configuration and specifications of the network. Thus, the provider can easily create and distribute an application that he or she wants to distribute to a user. In addition, since the service providing company collects fee for an application instead of the provider, it can save the labor for collecting the fee.

According to the present invention, a provider and/or a user can obtain a customized application or an order-made application that satisfies desired operating functions without need to have special technical knowledge such as development, language, specifications, and so forth for an application. In other words, an application that has only a function a user wants to use or a provider wants a user to use can be provided at cost corresponding to the function.

According to the present invention, the user can use one piece of data with a plurality of PCs or portable terminal units. In addition, one piece of data can be used by a plurality of third party members.

According to the present invention, since the service providing company provides an application to a user, the service providing company can collect a service fee from the user. In addition, since an application can be published on a HP of the service providing company, a HP publishing fee can be collected from the provider. In addition, member fees can be collected from a provider and/or a user.

According to the present invention, since a trend of users' favorites that are diverging time by time can be obtained from input items that the users have selected, marketing data and mining data can be collected, analyzed and sold.

According to the present invention, a HP of a service providing company can be provided to a HP of another person or another company. In addition, a HP of a service providing company can be sold as an OEM. When a HP is published on a HP of a service providing company, an advertisement income can be obtained.

According to the present invention, since one ID can be assigned whenever one application is installed, users and applications can be accurately and easily managed. In addition, an application can be prevented from being illegally copied.

1. An application creating system for creating application software that a user desires, the application creating system comprising:
a user's terminal unit connected through a network;
application managing means for managing the application software;
function selecting/inputting means for selecting and/or inputting a desired function of the managed application software with the user's terminal unit; and
application creating means for creating application software in accordance with the desired function that has been selected and/or input and specifications of the user's terminal unit that uses the application software.

2. The application creating system as set forth in claim 1, further comprising:
application registering means for registering a program source, a functional module, and/or an executable application of the application software.

3. The application creating system as set forth in claim 1,
wherein the application managing means is configured to pre-manage a program source and an executable module necessary for using the network.

4. The application creating system as set forth in claim 1,
wherein a control signal that causes model information that represents a model of the user's terminal unit and/or a version of an OS used in the user's terminal unit to be called is transmitted to the user's terminal unit, and
wherein the model information and/or the version of the OS is received from the user's terminal unit in accordance with the control signal.

5. The application creating system as set forth in claim 1, further comprising:
application providing means for providing the created application software to the user's terminal unit so that the created application software is used with the user's terminal unit.

6. The application creating system as set forth in claim 1, further comprising:
application managing•operating means for managing and operating the created application software so that the created application software is used with the user's terminal unit through the network.

7. The application creating system as set forth in claim 1,
wherein a unique identifier is added to the application software created by the application creating means.

8. The application creating system as set forth in claim 1,
wherein a message, an image, a moving picture, an animation, sound, and/or music that is presented by the application software is set when the application software is created by the application creating means.

9. The application creating system as set forth in claim 1,
wherein the application creating means is configured to create a plurality of versions of the application software having the same function so that the application software can operate with a plurality of units.

10. The application creating system as set forth in claim 1, further comprising:
state collecting means for collecting a working state and/or an operating state of the created application software.

11. An application creating apparatus for creating application software that a user desires, the application creating apparatus comprising:
application managing means for managing the application software;
function selecting/inputting means for selecting and/or inputting a desired function of the managed application software; and
application creating means for creating application software in accordance with the desired function that has been selected and/or input and specifications of a user's terminal unit that uses the application software,
wherein the application creating apparatus is controlled with the user's terminal unit connected thereto through a network.

12. The application creating apparatus as set forth in claim 11, further comprising:
application registering means for registering a program source, a functional module, and/or an executable application of the application software.

13. The application creating apparatus as set forth in claim 11,
wherein the application managing means is configured to pre-manage a program source and an executable module necessary for using the network.

14. The application creating apparatus as set forth in claim 11,
wherein a control signal that causes model information that represents a model of the user's terminal unit and/or a version of an OS used in the user's terminal unit to be called is transmitted to the user's terminal unit, and
wherein the model information and/or the version of the OS is received from the user's terminal unit in accordance with the control signal.

15. The application creating apparatus as set forth in claim 11, further comprising:
application providing means for providing the created application software to the user's terminal unit so that the created application software is used with the user's terminal unit.

16. The application creating apparatus as set forth in claim 11, further comprising:
application managing•operating means for managing and operating the created application software so that the created application software is used with the user's terminal unit through the network.

17. The application creating apparatus as set forth in claim 11,
wherein a unique identifier is added to the application software created by the application creating means.

18. The application creating apparatus as set forth in claim 11,
wherein a message, an image, a moving picture, an animation, sound, and/or music that is presented by the application software is set when the application software is created by the application creating means.

19. The application creating apparatus as set forth in claim 11,
wherein the application creating means is configured to create a plurality of versions of the application software having the same function so that the application software can operate with a plurality of units.

20. The application creating apparatus as set forth in claim 11, further comprising:
state collecting means for collecting a working state and/or an operating state of the created application software.

21. An application creating method for creating application software that a user desires, the application creating method comprising the steps of:
managing the application software;
selecting and/or inputting a desired function of the managed application software; and
creating application software in accordance with the desired function that has been selected and/or input and specifications of a user's terminal unit that uses the application software,
wherein the application creating method is controlled with the user's terminal unit connected thereto through a network.

22. The application creating method as set forth in claim 21, further comprising the step of:
registering a program source, a functional module, and/or an executable application of the application software.

23. The application creating method as set forth in claim 21, further comprising the step of:
pre-managing a program source and an executable module necessary for using the network.

24. The application creating method as set forth in claim 21, further comprising the steps of:
transmitting a control signal that causes model information that represents a model of the user's terminal unit and/or a version of an OS used in the user's terminal unit to be called to the user's terminal unit; and
receiving the model information and/or the version of the OS from the user's terminal unit in accordance with the control signal.

25. The application creating method as set forth in claim 21, further comprising the step of:
providing the created application software to the user's terminal unit so that the created application software is used with the user's terminal unit.

26. The application creating method as set forth in claim 21, further comprising the step of:
managing and operating the created application software so that the created application software is used with the user's terminal unit through the network.

27. The application creating method as set forth in claim 21, further comprising the step of:
adding a unique identifier to the created application software.

28. The application creating method as set forth in claim 21, further comprising the step of:
setting a message, an image, a moving picture, an animation, sound, and/or music that is presented by the application software when the application software is created.

29. The application creating method as set forth in claim 21, further comprising the step of:
creating a plurality of versions of the application software having the same function so that the application software can operate with a plurality of units.

30. The application creating method as set forth in claim 21, further comprising the step of:
collecting a working state and/or an operating state of the created application software.

31. An application providing system for providing application software that a user desires, the application providing system comprising:
a user's terminal unit connected through a network;
application managing means for managing the application software;
application creating means for selecting and/or inputting a desired function of the managed application software with the user's terminal unit and creating application software in accordance with the desired function that has been selected and/or input and specifications of the user's terminal unit; and
application providing means for providing the created application software to the user's terminal unit so that the created application software is used with the user's terminal unit.

32. The application providing system as set forth in claim 31, further comprising:
application registering means for registering a program source, a functional module, and/or an executable application of the application software.

33. The application providing system as set forth in claim 31,
wherein the application managing means is configured to pre-store a program source and an executable module necessary for using the network.

34. The application providing system as set forth in claim 31,
wherein a control signal that causes model information that represents a model of the user's terminal unit and/or a version of an OS used in the user's terminal unit to be called is transmitted to the user's terminal unit, and
wherein the model information and/or the version of the OS is received from the user's terminal unit in accordance with the control signal.

35. The application providing system as set forth in claim 31, further comprising:
application managing•operating means for managing and operating the created application software so that the created application software is used with the user's terminal unit through the network.

36. The application providing system as set forth in claim 31,
wherein a unique identifier is added to the application software created by the application creating means.

37. The application providing system as set forth in claim 31,
wherein a message, an image, a moving picture, an animation, sound, and/or music that is presented by the application software is set when the application software is created by the application creating means.

38. The application providing system as set forth in claim 31,
wherein the application creating means is configured to create a plurality of versions of the application software having the same function so that the application software can operate with a plurality of units.

39. The application providing system as set forth in claim 31, further comprising:
state collecting means for collecting a working state and/or an operating state of the created application software.

40. An application providing apparatus for providing application software that a user desires, the application providing apparatus comprising:
application managing means for managing the application software;
application creating means for selecting and/or inputting a desired function of the managed application software and creating application software in accordance with the desired function that has been selected and/or input and specifications of a user's terminal unit that uses the application software; and
application providing means for providing the created application software to the user's terminal unit so that the created application software is used with the user's terminal unit,
wherein the application providing apparatus is controlled with the user's terminal unit connected thereto through a network.

41. The application providing apparatus as set forth in claim 40, further comprising:
application registering means for registering a program source, a functional module, and/or an executable application of the application software.

42. The application providing apparatus as set forth in claim 40,
wherein the application managing means is configured to pre-store a program source and an executable module necessary for using the network.

43. The application providing apparatus as set forth in claim 40,
wherein a control signal that causes model information that represents a model of the user's terminal unit and/or a version of an OS used in the user's terminal unit to be called is transmitted to the user's terminal unit, and
wherein the model information and/or the version of the OS is received from the user's terminal unit in accordance with the control signal.

44. The application providing apparatus as set forth in claim 40, further comprising:
application managing•operating means for managing and operating the created application software so that the created application software is used with the user's terminal unit through the network.

45. The application providing apparatus as set forth in claim 40,
wherein a unique identifier is added to the application software created by the application creating means.

46. The application providing apparatus as set forth in claim 40,
wherein a message, an image, a moving picture, an animation, sound, and/or music that is presented by the application software is set when the application software is created by the application creating means.

47. The application providing apparatus as set forth in claim 40,
wherein the application creating means is configured to create a plurality of versions of the application software having the same function so that the application software can operate with a plurality of units.

48. The application providing apparatus as set forth in claim 40, further comprising:
state collecting means for collecting a working state and/or an operating state of the created application software.

49. An application providing method for providing application software that a user desires, the application providing method comprising the steps of:
managing the application software;
selecting and/or inputting a desired function of the managed application software and creating application software in accordance with the desired function that has been selected and/or input and specifications of a user's terminal unit that uses the application software; and
providing the created application software to the user's terminal unit so that the created application software is used with the user's terminal unit,
wherein the application providing method is controlled with the user's terminal unit connected thereto through a network.

50. The application providing method as set forth in claim 49, further comprising the step of:
registering a program source, a functional module, and/or an executable application of the application software.

51. The application providing method as set forth in claim 49, further comprising the step of:
pre-storing a program source and an executable module necessary for using the network.

52. The application providing method as set forth in claim 49, further comprising the steps of:
transmitting a control signal that causes model information that represents a model of the user's terminal unit and/or a version of an OS used in the user's terminal unit to be called to the user's terminal unit; and
receiving the model information and/or the version of the OS from the user's terminal unit in accordance with the control signal.

53. The application providing method as set forth in claim 49, further comprising:
application managing•operating means for managing and operating the created application software so that the created application software is used with the user's terminal unit through the network.

54. The application providing method as set forth in claim 49, further comprising the step of:
adding a unique identifier to the created application software.

55. The application providing method as set forth in claim 49, further comprising the step of:
setting a message, an image, a moving picture, an animation, sound, and/or music that is presented by the application software when the application software is created.

56. The application providing method as set forth in claim 49, further comprising the step of:
creating a plurality of versions of the application software having the same function so that the application software can operate with a plurality of units.

57. The application providing method as set forth in claim 49, further comprising the step of:
collecting a working state and/or an operating state of the created application software.

58. An application operating system for providing application software that a user desires, the application operating system comprising:
a user's terminal unit connected through a network;
application managing means for managing the application software;
application creating means for selecting and/or inputting a desired function of the managed application software with the user's terminal unit and creating application software in accordance with the desired function that has been selected and/or input and specifications of the user's terminal unit; and
application managing•operating means for managing and operating the created application software so that the created application software is used with the user's terminal unit through the network.

59. The application operating system as set forth in claim 58, further comprising:
application registering means for registering a program source, a functional module, and/or an executable application of the application software.

60. The application operating system as set forth in claim 58,
wherein the application managing means is configured to pre-store a program source and an executable module necessary for using the network.

61. The application operating system as set forth in claim 58,
wherein a control signal that causes model information that represents a model of the user's terminal unit and/or a version of an OS used in the user's terminal unit to be called is transmitted to the user's terminal unit, and
wherein the model information and/or the version of the OS is received from the user's terminal unit in accordance with the control signal.

62. The application operating system as set forth in claim 58, further comprising:
application providing means for providing the created application software so that the created application software is used with the user's terminal unit.

63. The application operating system as set forth in claim 58,
wherein a unique identifier is added to the application software created by the application creating means.

64. The application operating system as set forth in claim 58,
wherein a message, an image, a moving picture, an animation, sound, and/or music that is presented by the application software is set when the application software is created by the application creating means.

65. The application operating system as set forth in claim 58,
wherein the application creating means is configured to create a plurality of versions of the application software having the same function so that the application software can operate with a plurality of units.

66. The application operating system as set forth in claim 58, further comprising:
state collecting means for collecting a working state and/or an operating state of the created application software.

67. An application operating apparatus for providing application software that a user desires, the application operating apparatus comprising:
application managing means for managing the application software;
application creating means for selecting and/or inputting a desired function of the managed application software and creating application software in accordance with the desired function that has been selected and/or input and specifications of a user's terminal unit that uses the application software; and
application managing•operating means for managing and operating the created application software so that the created application software is used with the user's terminal unit through the network,
wherein the application operating apparatus is controlled with the user's terminal unit connected thereto through a network.

68. The application operating apparatus as set forth in claim 67, further comprising:
application registering means for registering a program source, a functional module, and/or an executable application of the application software.

69. The application operating apparatus as set forth in claim 67,
wherein the application managing means is configured to pre-store a program source and an executable module necessary for using the network.

70. The application operating apparatus as set forth in claim 67,
wherein a control signal that causes model information that represents a model of the user's terminal unit and/or a version of an OS used in the user's terminal unit to be called is transmitted to the user's terminal unit, and
wherein the model information and/or the version of the OS is received from the user's terminal unit in accordance with the control signal.

71. The application operating apparatus as set forth in claim 67, further comprising:
application providing means for providing the created application software so that the created application software is used with the user's terminal unit.

72. The application operating apparatus as set forth in claim 67,
wherein a unique identifier is added to the application software created by the application creating means.

73. The application operating apparatus as set forth in claim 67,
wherein a message, an image, a moving picture, an animation, sound, and/or music that is presented by the application software is set when the application software is created by the application creating means.

74. The application operating apparatus as set forth in claim 67,
wherein the application creating means is configured to create a plurality of versions of the application software having the same function so that the application software can operate with a plurality of units.

75. The application operating apparatus as set forth in claim 67, further comprising:
state collecting means for collecting a working state and/or an operating state of the created application software.

76. An application operating method for providing application software that a user desires, the application operating method comprising the step of:
managing the application software;
selecting and/or inputting a desired function of the managed application software and creating application software in accordance with the desired function that has been selected and/or input and specifications of a user's terminal unit that uses the application software; and
managing and operating the created application software so that the created application software is used with the user's terminal unit through the network,
wherein the application operating method is controlled with the user's terminal unit connected thereto through a network.

77. The application operating method as set forth in claim 76, further comprising the step of:
registering a program source, a functional module, and/or an executable application of the application software.

78. The application operating method as set forth in claim 76, further comprising the step of:
pre-storing a program source and an executable module necessary for using the network.

79. The application operating method as set forth in claim 76, further comprising the steps of:
transmitting a control signal that causes model information that represents a model of the user's terminal unit and/or a version of an OS used in the user's terminal unit to be called to the user's terminal unit; and
receiving the model information and/or the version of the OS from the user's terminal unit in accordance with the control signal.

80. The application operating method as set forth in claim 76, further comprising the step of:
providing the created application software so that the created application software is used with the user's terminal unit.

81. The application operating method as set forth in claim 76, further comprising the step of:
adding a unique identifier to the created application software.

82. The application operating method as set forth in claim 76, further comprising the step of:
setting a message, an image, a moving picture, an animation, sound, and/or music that is presented by the application software when the application software is created.

83. The application operating method as set forth in claim 76, further comprising the step of:
creating a plurality of versions of the application software having the same function so that the application software can operate with a plurality of units.

84. The application operating method as set forth in claim 76, further comprising the step of:
collecting a working state and/or an operating state of the created application software.
